(19) United States
(12) Patent Application Publication
(10) Pub. No.: US 2025/0377193 A1
(43) Pub. Date: Dec. 11, 2025

(54) COORDINATE MEASURING MACHINE WITH COUNTERWEIGHT MEMBER

(71) Applicant: HEXAGON TECHNOLOGY CENTER GMBH, Heerbrugg (CH)

(72) Inventors: Karl Helmut PLANGGER, Dornbirn (AT); Jan ZÜLLIG, Neukirch (CH); Jochen SCHEJA, Hohenems (AT)

(73) Assignee: HEXAGON TECHNOLOGY CENTER GMBH, Heerbrugg (CH)

(21) Appl. No.: 18/907,346

(22) Filed: Oct. 4, 2024

(30) Foreign Application Priority Data
Oct. 5, 2023 (EP) 23201940.6

(51) Int. Cl. G01B 5/008

(52) U.S. Cl. CPC G01B 5/008

(57) ABSTRACT

A CMM comprising, a base, articulated elements, a counterweight, internal sensors, a control unit and a probe. The counterweight is associated with a first segment and hinge and configured to provide a counterweight torque to the first hinge having an opposite direction to a gravitational torque. The counterweight comprises a force-providing element and a mechanism. The mechanism comprises a static element mounted on an axis of the first hinge and a rotary element kinematically linked to the static element. The shape of the static element is configured to set the counterweight torque. The mechanism further comprises a internal support configured to interact with an interaction area of the first segment.

### FIELD

The present disclosure relates to a structure and operation of a coordinate measuring machine (CMM), in particular a substantially manually driven articulated arm coordinate measuring machine (AACMM). The CMM comprises a base, articulated elements, a counterweight member, internal sensors, a control unit and a probe. The counterweight member is configured to provide a torque having opposite direction to a torque caused by weight of the articulated elements.

### BACKGROUND

A CMM is a machine configured to measure 3D coordinates of certain points, in particular the whole surface topography, of a workpiece. CMMs are important in various industries e.g., in production measurement, quality control, or reverse engineering. They are used e.g., to determine deviations of the geometry of manufactured products from a design model, in particular to determine whether the deviations are within the manufacturing tolerance. Another application of a CMM gaining more prominence is the reverse engineering of an object. In such cases no design model exists, but an operator provides a guidance of the probe. While these tasks can be performed with a fully motorized system, such CMMs are typically heavy, stationary equipment. Moreover, to effectively utilize the accuracy of such CMMs they are often located in dedicated measurement laboratories/workshops with controlled environment parameters. This, however, causes sluggish feedback between the manufacturing and quality control, especially when additional workpiece conditioning is necessary.

Portable measurement arms offer a flexible, time and cost-efficient alternative to the above measurement setups. Portable measurement arms comprise a base to connect the machine to a typically inert support structure, a set of articulated elements, a set of internal sensors providing data regarding the state of said elements, a probe interface configured to accommodate a probe, typically exchangeably, and a plurality of probes. The probe is configured to interact with the workpiece in tactile and/or in non-contact manner. Coordinate data of object points on the workpiece are derived based on the state of the articulated elements and a data provided by a probe. Unless otherwise stated and/or it would complicate understanding, real, physical objects/phenomena and data about the respective real, physical objects/phenomena are used synonymously.

Many designs are at least theoretically feasible for the types and arrangement of the articulated elements of portable measurement arms. However, practical considerations, e.g., the requirements of ultra-high accuracy, low weight, large accessible volume, lead to a preferred embodiment in which the arm comprises a series of hinges and elongated cylinders allowing rotation about their axis, typically by a component located at the distal end of the cylinders. In addition, most articulated elements are non-motorized. In other words, the probe head is manually guided by an operator providing a decisive part of the driving force for the movement of the articulated elements by muscle power.

To achieve a large accessible volume and/or to provide alternative measurement path AACMMs are typically underdetermined as mechanical systems. I.e., the same probe posture can be realized by many different postures of the articulated elements. Particularly important, therefore, is the question of the gravity acting on the intermediate articulations. The compensation of the gravity requires support of one of the intermediate articulations. Manually providing such support, e.g., holding one of the intermediate articulations by the other hand of the operator, could result in excessive workloads in the form of sustained, non-natural poses and/or fatigue from holding a significant weight. Moreover, the size and weight of contemporary portable measurement arms means that considerable torques exceeding 10 Nm might act on the first hinge. I.e., uncontrolled movements of the AACMM might lead to injury or considerable material damage.

Prior art solution exists to mitigate the effects of gravity at least partly by utilizing different types of counterweight members. Prior art counterweight members, however, either increase the weight of the instrument as a whole and/or negatively influence the accuracy. In addition, sufficient compensation is often not possible, i.e., the operator still has to support one of the intermediate joints with his other hand. Some of the prior art concepts are shown in FIGS. 2 to 5.

### SUMMARY

In view of the above circumstances, one object is to improve the handling of the articulated arm CMM, particular to at least reduce the workload caused by supporting heavy weights and sustained non-natural postures.

A second objective is to improve the measurement accuracy of the articulated arm CMM.

A third objective is to reduce the risk of collisions of the articulated elements with the environment and/or of falling of the articulated elements that could cause injury or damage the CMM and/or the workpiece.

The disclosure relates to a CMM, more particularly a substantially manually driven, AACMM. Substantially manually driven in the sense of the disclosure means that the operator of the AACMM touches one or more components of the measuring arm and guides the probe thereby.

The CMM comprises a base, a set of articulated elements, a counterweight member, a set of internal sensors, a control unit and a probe.

The set of articulated elements comprises a first segment connected to the base by a first hinge, a second segment connected to the first segment by a second hinge, and a probe interface connected to the second segment by a third hinge.

The probe interface is configured to accommodate a probe. The probe is configured to provide probe data regarding an object point in the environment. The probe might be a tactile probe configured to provide probe data by mechanically interacting with the object point. However, the disclosure is equally applicable with non-contact probes such as triangulation sensors, laser scanners or ultrasound probes. The probe interface might provide further degrees of freedom regarding the movement of the probe. The probe interface might comprise an operator interaction element configured (a) to provide a better grip for the operator and/or (b) to enable an activation of direct operator commands.

Segments provide at least partial rotatability about an axis substantially parallel to a longitudinal axis of the segments, in particular a distal portion of the segments might be rotatable with respect to the proximal portion. Hinges in the context of the disclosure provide at least partial rotatability about an axis which is angled with respect to the axes of the connected segments, in particular perpendicular thereto. While it is advantageous for contemporary AACMMs to use one degree of freedom articulated elements, due to improved pose reproducibility and measurement accuracy, the disclosure is not limited to such designs.

Each sensor in the set of internal sensors is associated with at least one of the articulated elements and configured to provide internal sensor data regarding the associated element. In other words, at least the rotation state of each of the articulated elements is tracked by the appropriate sensors. A part of the internal sensors, in particular the displacement and/or force measuring sensors might provide data regarding a plurality of the articulated elements. A part of the articulated elements might be associated with a plurality of internal sensors. Alternatively, a sensor might be realized as a distributed sensor comprising a plurality of physically distinct sensor components and the sensor data is provided by the assembly as a whole.

The control unit is configured to derive (a) a pose change of the probe based on the internal sensor data, and (b) coordinate data of the object point based on the internal sensor data and the probe data. Coordinate data might be relative coordinates to further object points in the environment. Control units can be realized in many ways, a non-exclusive list comprises (i) one or more local controllers integrated with the CMM, and/or (ii) one or more generic computers located in the proximity of the CMM, and/or (iii) remote, in particular cloud based, controlling or a combination thereof.

The counterweight member is associated with the first segment and the first hinge and configured to provide a counterweight torque to the first hinge having an opposite direction to a gravitational torque acting on the first hinge. The inventive counterweight member comprises a force-providing element and a mechanism. The mechanism comprises a rotary element, a static element and an internal support. The force providing element provides a force to the rotary element, in particular directly. The static element is mounted on an axis of the first hinge and kinematically linked to the rotary element. A shape of the static element is configured to set the counterweight torque as a function of a rotation state of the first hinge. The internal support is configured to receive an input force and/or torque from the rotating element and configured to provide an output force and/or torque to an interaction area of the first segment. The interaction area is located closer to the second hinge than the first hinge, and the output force and/or torque has a lower magnitude than the input force and/or torque.

Static element in the sense of the disclosure means that said element is mounted on the axis of the first hinge in a fixed pose. For designs wherein the axis is integrated with the base the static element has a fixed pose with respect to the base. The shape of the static element includes aspects resulting from the true geometric shape and/or an eccentric and/or angled position with respect to the axis of the first hinge. From here shape is understood as the resulting effective shape of the static element. The resulting shape is not rotation symmetric.

The rotary element is configured to be displaceable with respect to the static element at least by a rotation movement. Kinematically linked in the sense of the disclosure means that the freedom of movement of the rotary element is restricted by the static element, in particular the shape of the static element determines a path of the rotary element. The rotary element might be in direct mechanical contact with the static element. Alternatively, the interaction is provided by intermediary elements. The rotary element might be geared to interact with the force providing element. The force providing element might comprise a rod or any suitable alternative to act on the rotary element.

The support structure is considered to interact with the first segment essentially only at the interaction area. In other words, the support structure can be seen as a component, which partially absorbs the forces, in particular the transverse forces, occurring in the mechanism. By limiting the interaction to the interaction area, the deformation of the support structure have at most a limited effect on the first segment. In other words, the support structure at least reduces, preferably eliminates the influence of the transverse force on the first segment.

In some embodiments, the first and second segments are elongated and configured to provide a rotation about rotation axes aligned with the direction of elongation. Aligned in the sense of the disclosure means that the rotation axis and the direction of the elongation are substantially the same. In some specific embodiments, the first and second segments are substantially cylindrical. The first and second segments might comprise (a) a proximal end rigidly connected to the proximal side hinges, (b) a distal end rigidly connected to distal side hinges, and (c) a bearing mechanism providing a rotation between the proximal and distal ends. The first and second segments might comprise areas configured to be held/manipulated by the operator. These areas provide better grip and/or thermal insulation, mitigating the inaccuracies caused by warming from the operator's grip.

In some embodiments, the force-providing element comprises a spring, in particular a coil spring. In some specific embodiments, the spring is a pressure spring. In some specific embodiments, the spring is located within the first segment, i.e. between the first hinge and the second hinge, and aligned to the rotation axis of the first segment. The spring is configured to provide a force substantially independent from the rotation state of the first segment. In other words, a spring associated with, in particular mounted inside of, the first segment provides a force acting on the rotary element. Pressure springs carry the advantage that they minimize the risk of catastrophic failure. Nevertheless, other spring designs, in particular leaf, or torsion springs, might be equally applicable.

In some embodiments, the first segment comprises a rigid first segment shell. The first segment shell interacts with the internal support only through the interaction area. In some specific embodiments, the interaction area is at least five times farther from the first hinge than the second hinge. In other words, the first segment shell bears as little load as possible within the design parameters. The advantage of this construct is that the first segment shell experiences the least deformation possible which increases the measurement accuracy. Alternatively, or additionally an interaction sensor configured to provide sensor data regarding the output force and/or torque is arranged to the interaction area. In such embodiments, the interaction sensor provides data regarding a possible bending or other kinds of deformations of the first segment shell. From here on, unless otherwise specified, only embodiments, wherein the first segment shell is in substantially force-free state are discussed in detail.

In some embodiments, the static element is a cam. The shape of the cam is designed such that the counterweight torque arising from an interaction of the rotary element and the static element at least approximately compensates the gravitational torque acting on the first hinge. Compensation in the sense of the disclosure covers partial—or overcompensation, i.e., a net torque acting on the first hinge causes a rotation having opposite direction than the one caused by gravity.

In some specific embodiments, the mechanism comprises a plurality of cams each having different shapes. A selection element configured to set one of the cams to act as the static element. The plurality of cams is configured for different operational modes of the AACMM, e.g. different operational modes representing different rotation states of the second hinge. Additionally, or alternatively the mechanism might comprise a cam with a plurality of surfaces. A first manual adjustment element is configured to set one of the plurality of surfaces to act as the static element.

In some specific embodiments, the mechanism comprises a second manual adjustment element configured to adjust the pose of the rotary element, in particular the second manual adjustment element comprises a sliding element, a thread, or a screw.

In some specific embodiments, the mechanism comprises a third manual adjustment element configured to adjust a magnitude of the force exerted by the force providing element. In particular the third manual adjustment element comprises a sliding element, a thread, an excenter or a screw. The third manual adjustment element might be foreseen to compensate the effects of wear and tear on the spring. All the plurality of cams, first, second and third manually adjustment elements allow a robust, purely mechanical extension of the functionalities of the AACMM. Such mechanical adjustment nonetheless might be beneficially combined with active motorized components, by reducing the range to be controlled and thereby the power requirements of the motors.

In some embodiments, the shape of the static element, in particular wherein the static element is a cam, is designed provide a stable position and a stability range for the first hinge. Within the stability range a net torque, comprising the gravitational and counterweight torques, causes a rotation of the first hinge towards the stable position. The advantages of the stability range are twofold. Firstly, the stability range might provide a safe parking position, i.e., the operator might temporarily interrupt a measurement and leave the AACMM in the safe parking state. Secondly, the stability range might also provide a stable, preferred orientation for the first segment. This is beneficial e.g., for measurement operation wherein large reach is required, which is typically achieved by orienting the first segment near horizontally. Owing to the stability range the operator can perform the measurement without having to worry about the proper positioning and manually supporting the segment. It is clear for the skilled person that the static element can be designed to provide a plurality of stability ranges, in particular to realize both of the above-mentioned functionalities. Especially advantageous is that by keeping a near-constant orientation the biases and the accuracies of the sensors remain also near constant during the measurement task. This improves the reproducibility of the probe pose and thereby the precision of the measurement. The stable position and the stability range, while not limited to, is therefore to be interpreted in the context of improved measurement accuracy during the finer movement of the AACMM.

In some specific embodiments, the static element comprises a neutral point and the stable position corresponds to the neutral point of the static element. Advantageously, the here described stabilization is achieved passively by a mechanical design, i.e. without the involvement of a controller or a motorized element. Such mechanical functionalities nevertheless might be beneficially combined with active controlled motorized components, by reducing the range to be actively controlled and thereby the power requirements of the motors.

In some specific embodiments, the shape of the static element is designed to provide a lift range for the first hinge. Within the lift range the net torque causes an upward rotation of the first hinge. Such lift range might provide a crash protection functionality, in particular the lift range corresponds to one of (a) a vertical position of the probe interface is below a vertical position of the first hinge, and/or (b) a vertical position of the second hinge is below a vertical position of the first hinge.

In some embodiments the CMM is configured, based on the pose of the second hinge, to automatically adjust (a) the force provided by the force providing element, and/or (b) the pose of the rotary element. Automatic adjustment in the sense of the disclosure might be provided by appropriate passive mechanical elements or by a motorized component. Unlike to the prior art, however, a major part of the counterweight torque is provided by the spring, i.e. a smaller, more compact motor is sufficient for the inventive AACMM.

In some specific embodiments, the set of internal sensors comprises a second hinge pose sensor, and the control unit is configured to provide the adjustment based on data provided by the second hinge pose sensor.

In some embodiments the mechanism comprises a further rotary element kinematically linked to the rotary element. A rotation of the rotary element causes a position change of a rotation axis of the further rotary element along a constrained path. The further rotary element is in point or line contact with the static element. In other words, the further rotary element is constrained to be in tangency with the static element. The axis of the first hinge has an offset to a line defined by a contact point between the further rotary element and the static element and the rotation axis of the further rotary element. The shape of the static element is configured to define the offset as a function of the rotation state of the first hinge. I.e., for rigid mechanical components the force acts along the surface normal, which for components with circular cross section is the radial direction.

The lever arm of counterweight torque is defined by the offset of the line connecting the rotation axis of the further rotary element and a contact point, e.g., a point representing the contact line, from the axis of the first hinge. In some specific embodiments, the rotary element is a lever gear, and the further rotary element is a roller, in particular a cylindrical roller, mounted on the lever gear in a position offset to a rotation axis of the level gear.

In some specific embodiments, the counterweight member comprises a friction element configured to provide a friction torque for the first hinge. In some specific embodiments, the friction element is comprised by the mechanism, in particular arranged to the axis of the first hinge.

In some specific embodiments, the friction element causes a motionless parking state of the first hinge, in particular by blocking the rotation of the rotary element. The motionless parking state might be activated in an absence of forces exerted by the operator on one of articulated elements and/or as a result of a parking command provided by the operator. The command might be provided by mechanical elements, e.g., a lever or switch, or electronically, in particular as a software command. The friction torque can be limited to a maximum torque or break of torque to prevent damage of the system in case of a malfunction or overload by the user.

In some embodiments, the friction element comprises (a) an active component, in particular electromagnetic actuated clutch/brake piston, and/or (b) an eddy-current brake, and/or (c) a thixotropic and/or magnetodynamic component, in particular a bearing comprises a thixotropic and/or magnetodynamic fluid, and/or (d) a centrifugal clutch, and/or (e) a form lock.

In some embodiments, the friction element is configured to provide a non-linear change of the friction torque dependent on (a) the rotation state and/or a motion speed of the first hinge, and/or (b) the rotation state and/or a motion speed of the probe interface. The friction element might comprise a flex rachet handle configured to block a downward a movement of the first hinge in an engaged state. The flex rachet handle is configured to enable an upward movement both in the engaged and disengaged state. The friction element might also comprise a user interaction element arranged to the proximity of the flex rachet handle and configured to activate and deactivate the engaged state. Some embodiments of the user interaction element operate purely mechanically, i.e., by direct transfer of a force exerted by the user. Alternatively or additionally, the flex ratchet handle might comprise an overload protection causing an automatic termination of the engaged state if a torque acting on the first hinge exceeds an override threshold. Said overload protection might be realized by passive mechanical components, in particular by the shape and arrangement of the components of the friction element.

The friction element according to the disclosure could serve two different purposes. On the one hand the friction element might provide a locking functionality, with “infinite” friction torque limit. On the other hand the friction element might provide an attitude/velocity dependent friction torque i.e. the friction torque might be high in the danger zones, e.g. for coarse movement near the specimen, but might be low far away from the danger-zones. A friction element in the sense of the disclosure could provide any one of these or both of these functionalities.

Alternatively or additionally, the friction element might be configured to provide a high-speed friction torque associated with a position change, e.g. fast movement far away from the workpiece, and a low-speed friction torque associated with a measurement condition, e.g. fine movement near the workpiece. The low-speed friction torque is lower than the high-speed friction torque, in particular substantially zero. That the resistance is essentially zero for fine movements would not only improve measurement accuracy and efficiency, but also give the perception that the operator is using a fine, light tool associated with such jobs. In contrast, coarse movements are accompanied more frequently by the exertion of perceptible forces. This is reproduced by the increased high-speed friction torque.

In some embodiments, the set of internal sensors comprises a measurement condition sensor configured to provide measurement condition sensor data regarding operator actions. The control unit is configured to activate the measurement condition based on the measurement condition sensor data. In some specific embodiments, the measurement condition sensor comprises a force sensor and/or an acceleration sensor and/or a touch sensor. The measurement condition sensor data comprises data about a force exerted by an operator, and/or an observed acceleration of the probe interface and/or a presence of a grip by an operator and/or a distance from the workpiece.

In some embodiments, an upper and/or a lower safety level is defined regarding the rotation state of the first hinge. The friction element is configured to provide an increment of the friction torque when the rotation state of the first hinge approaches one of the safety levels. In some specific embodiments, the set of internal sensors provides crash protection data based on the rotation state of the first hinge, and the control unit is configured to provide commands to increase the friction torque based on the crash protection data. The safety levels and/or crash protection data, while not limited to, is mainly to be understood in the context of the position change condition. Safety levels might be provided in a gesture-controlled manner.

In some embodiments, the rotary element is a geared wheel, geared belt or geared lever, the force providing element comprises a motor, and the control unit is configured to provide control commands to the motor. A motor in the sense of the disclosure might provide a major part of the counterweight torque or even the complete counterweight torque. A motor might also be an auxiliary component, wherein the motor provides only a part of the counterweight torque, in particular the motor might provide a balancing torque.

In some embodiments, the motor comprises a gearbox, and the rotary element is in contact with the gearbox. Contact in the sense of the disclosure means that an output element of the gearbox is directly acting on the rotary element.

In some specific embodiments, the gearbox is configured to decouple the motor from the rotary element, and/or the gearbox comprises a manually controllable force setting element configured to provide operator settings to the gearbox to adjust the counterweight torque in the measurement condition, and/or the control unit is configured to provide settings to the gearbox to adjust the counterweight torque in the measurement condition based on a stored settings database.

In some embodiments, the friction element comprises the motor. The motor might provide the friction torque passively, i.e., as an electromagnetic brake, or actively. When the motor acts as an active friction element the control unit might dynamically set the appropriate torque. The motor can provide advanced functionalities to the ones described for the friction element. E.g., the motor can not only retard or block a motion but can also guide it actively. In other words, it can not only stop/rest the articulated element, but also actively move it in the desired direction or position.

In some embodiments, the force providing element comprises the spring and the motor. A first hinge sensor is configured to provide net torque data regarding the net torque acting on the first hinge. The control unit is configured to provide a balancing functionality comprising (a) receiving and processing the net torque data, (b) providing commands to the motor to provide a balancing torque such that the net torque acting on the first hinge approaches a target torque, in particular zero. The balancing functionality can be efficiently combined with the measurement condition, e.g., fine movement near the workpiece.

In some specific embodiments, the balancing torque limited is to a magnitude of ±30%, more particularly ±20% of the counterweight torque. Such embodiments are beneficial as the relaxed requirements regarding the power enable the utilization of lighter and/or more precise motors.

In some specific embodiments, the balancing torque is limited by a balancing threshold such that the balancing functionality is deactivated if the balancing torque exceeds the balancing threshold, e.g., in response to a force or torque exerted by an operator action. In alternate words, the operator can override the stabilization of the AACMM by gesture control, i.e., by departing from the workpiece. The control unit might provide a command to activate the position change condition in response.

In some embodiments, the CMM comprises an operator action sensor configured to provide operator action data regarding an operator guidance of one of the articulated elements. The operator action sensor might comprise a force sensor and/or an acceleration sensor and/or a touch sensor. The CMM is configured to access measurement configuration data, in particular regarding the settings of the force providing element, and/or the mechanism, and/or the friction element. The CMM is configured to provide an assistance functionality comprising (a) receiving and processing the operator action data, (b) deriving a guidance torque acting on the first hinge based on the operator action and measurement configuration data, and (c) providing commands to the motor to provide an assistance torque acting on the first hinge, in particular wherein the assistance torque has the same direction and at least the same magnitude as the guidance torque.

In some embodiments, the second hinge comprises a second counterweight member analogous to one of the embodiments of the counterweight member. The second counterweight member might have a design differing from the counterweight member, in particular a simplified design.

### BRIEF DESCRIPTION OF THE DRAWINGS

By way of example only, specific embodiments will be described more fully hereinafter with reference to the accompanying figures, wherein:

FIG. 1 illustrates the functioning of a generic AACMM;

FIG. 2a-2c illustrate the functioning of a prior art counterweight member with passive counterbalance;

FIGS. 3a and 3b illustrate the functioning of a prior art counterweight member with pneumatic spring;

FIGS. 4a and 4b illustrate the functioning of a prior art counterweight member with motor;

FIG. 5 illustrates a prior art counterweight member with coil spring and cam;

FIG. 6 illustrates a first embodiment of the inventive counterweight member with a coil spring as force providing element;

FIG. 7 illustrates a second embodiment of the inventive counterweight member with a leaf spring as force providing element;

FIG. 8 illustrates a third embodiment of the inventive counterweight member with a spring and a motor as force providing elements;

FIGS. 9a and 9b illustrate the stable position of the first hinge provided by a concave shaped cam;

FIG. 10 illustrates exemplary manual adjustment possibilities.

FIG. 11 illustrates the determination of coordinate data by a flowchart.

FIG. 12 illustrates, by a flowchart, an embodiment of the crash protection functionality.

FIG. 13 illustrates, by a flowchart, an embodiment of the balancing functionality.

FIG. 14 illustrates, by a flowchart, an embodiment of the assistance functionality.

### DETAILED DESCRIPTION

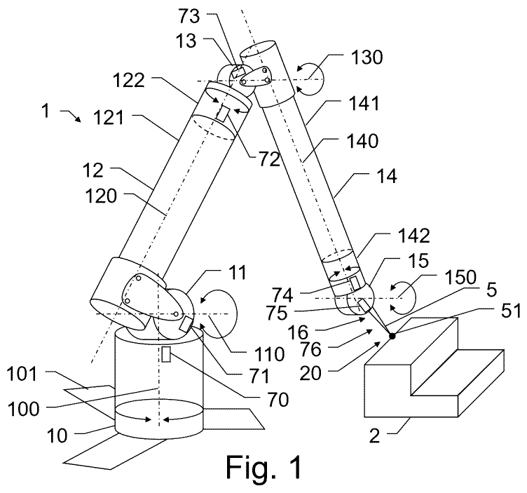

FIG. 1 depicts schematically a generic AACMM 1 performing a coordinate measurement on a workpiece 2. The AACMM is equipped with a tactile sensor as the probe 5 mounted on the probe interface 16, i.e., the operator performs the AACMM measurement by touching the object point 20 with a tactile sensing element 51, depicted as ruby sphere. The AACMM 1 comprises a base 10 with fixing elements 101, e.g., permanent magnets, screws, pneumatic components etc., configured to provide a mechanical coupling with the environment in a fixed pose relative to the workpiece 2. The AACMM 1 also comprises a set of articulated elements 11-16, comprising a first hinge 11 connecting the first segment 12 to the base 10, a second hinge 13 connecting the second segment 14 to the first segment 12 and a third hinge 15 connecting the probe interface 16 to the second segment 14. Each of the articulated elements 11-16 and the base 10 provide a single rotary degree of freedom about respective axes 100,110,120,130,140,150. Respective sensors 70-76 (only schematically indicated) are associated with the base 10 and each of the articulated elements 11-16 and provide sensor data regarding the associated element. The segments 12,14 are elongated cylinders and the axes of rotation 120,140 correspond to the directions of elongation. The segments 12,14 comprise a proximal side 121,141 rigidly connected to the respective proximal hinges 11,13 and a distal part 122,142 providing the rotation about the axis of the segment 120,140. The distal part is rigidly connected to the respective distal side hinges 13,15. In the depicted embodiment the proximal portion of the hinges 11,13,15 have a fixed spatial relationship with the respective proximal side component 10,12,14. While many of the features are illustrated utilizing the embodiment depicted in FIG. 1, the present disclosure is not limited to this embodiment. The specific features of other embodiments might be applied respectively.

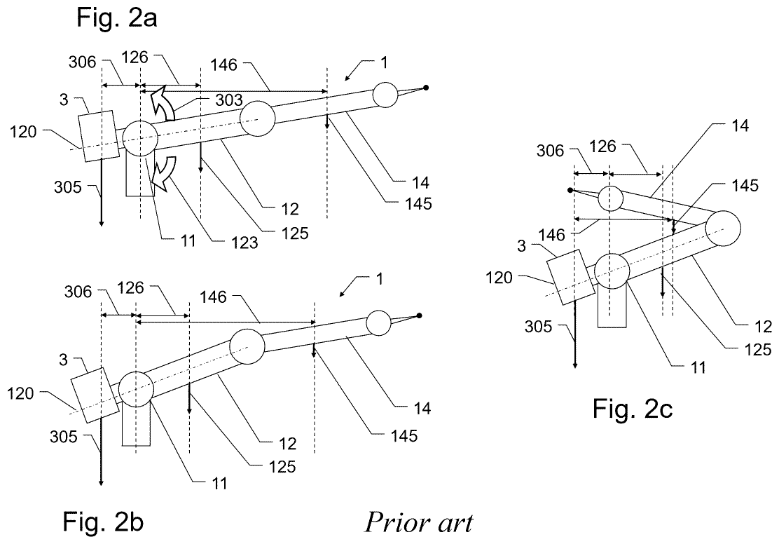

FIGS. 2a-2c depict schematically a prior art AACMM 1 comprising a counterweight member 3 as an actual counterweight mounted along the axis 120 of the first segment 12 on the opposite side of the first hinge 11. The first hinge 11 experience a gravitational torque 123 arising from the gravity acting on the different articulated elements 12,14 and a counterweight torque 303. In the depicted embodiment the counterweight torque 303 arising from the gravity acting on the counterweight member 3. The depicted torques arise from the forces 125,145,305 multiplied by the respective lever arms 126,146,306. For transparency reasons only the first 12 and second segments 14 are considered in this figure.

An advantage of this design is that the counterweight torque 303 provided by the counterweight member 3 is proportional to the gravitational torque caused by the weight of the first segment 12 for any rotation state of the first hinge. However, to provide an equal torque either the lever arm 306 relating to counterweight member 3 has to be comparable to the lever arm 126 relating to the first segment 12, which would make the operation of the AACMM 1 unwieldy, or the counterweight member 3 has to be proportionally heavier which would impact the portable nature of the instrument. Furthermore, a substantial part of the torque arising from the weight of the higher order members, e.g., the second segment 14. Such counterbalance-based counterweight member 3 on its own cannot compensate the change of the torque, i.e., for the situations as depicted in FIG. 2c the net torque would lead to a counterclockwise rotation of the first hinge.

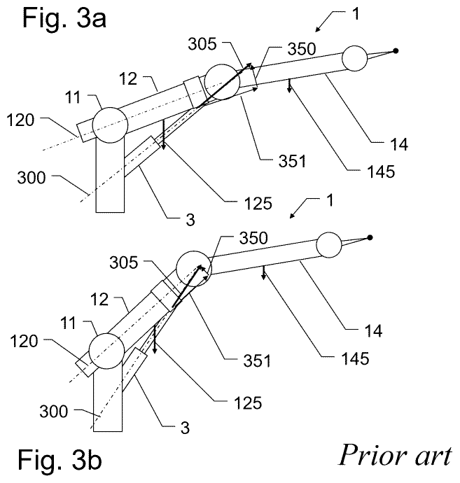

FIGS. 3a and 3b depict another prior art AACMM 1 with a counterweight member 3 comprising a pneumatic spring. The advantage of a pneumatic spring is its lightweight construction. To provide the counterweight torque the spring must be arranged such that it is offset to the first segment 12 and its axis 300 is angled to the axis 120 of the first segment. The counterweight force 305 acting along the axis 300 of the pneumatic spring comprises a portion perpendicular 350 and parallel 351 to axis 120 of the first segment. The parallel 351 and transverse 350 portions vary differently than the respective portions of the gravity 125. The magnitude of the force 305 also varies due to the variation in the strain state. I.e., with such a design not even the torque arising from the weight 125 of the first segment 12 let alone the torque arising from the weight 145 of the second segment 14 is compensated independently of the rotation state of the first hinge 11. Current pneumatic springs possess a considerable friction, which negatively influences operator comfort and measurement precision. Moreover, pneumatic springs wear relatively quickly, i.e., for optimal accuracy frequent replacement of the pneumatic spring is required.

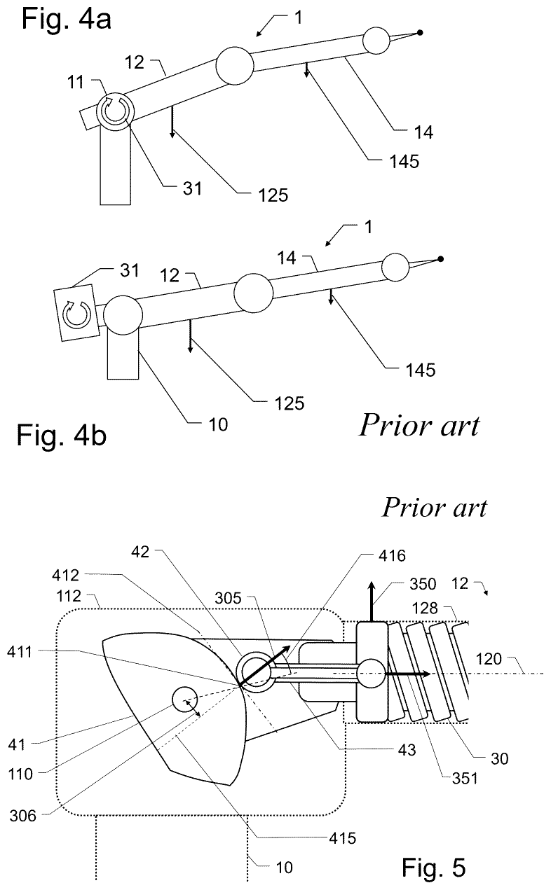

FIGS. 4a and 4b depict another prior art AACMM 1 with a motorized 31 counterweight member providing the counterweight torque. Similar embodiments are disclosed e.g., in U.S. Pat. No. 10,895,445 B2. In FIG. 4a the motor 31 is arranged to the first hinge 11, while in the embodiment depicted in FIG. 4b it is arranged coaxial to the first segment 12. The motor might also be arranged to the base 10. The advantage of a motor 31 as counterweight member is the ability to compensate the torque arising from the weight 125,145 of all articulated elements, only the first 12 and second segments 14 are depicted. A clear disadvantage is the cost, i.e., requirements for the motor 31 are rather strict regarding the weight, maximal torque, precision, and compactness. Moreover, unless an appropriate sensor suite is provided the motor might also try to compensate the torque arising from operator action, which potentially makes the usage of such AACMMs cumbersome.

FIG. 5 schematically depicts another prior counterweight member associated with the first hinge 11 and the first segment 12 based on a coil spring arranged along the axis 120 of the first segment 12, e.g. as disclosed in U.S. Pat. No. 6,253,458 B1. The spring 30 as force providing element acts on a rotary element 42, depicted as a roller, via a rod 43. The rod 43 transfers the spring force, i.e., the parallel component 351 of the counterweight force 305, to the rotary element 42. The first segment 12 is in a fixed spatial relationship with the housing 112 of the first hinge, and the movement of the rotary element 42 causes a rotation of the housing 112.

The counterweight member comprises a cam as a static element 41 mounted on the axis 110 of the first hinge. The axis 110 of the first hinge is in a fixed spatial relationship (not shown) with the base 10. The kinematical link between the rotary 42 and static elements 41 in the depicted embodiment is a tangency or point contact. The counterweight force 305, i.e., the contact force between the rotary 42 and static elements 41 acts in a direction perpendicular to the surface tangent 412 of the cam 41 at the point of contact 411. In other words, the pressure angle 416 is defined by the shape of the static element 41. Since the action line 415 of the counterweight force 305 is offset to the rotation axis 110 of the first hinge with a lever arm 306 a counterweight torque is generated. Since the lever arm of the gravity is more than ten times the lever arm 306 of the counterweight force 305 the latter must be proportionally large. Moreover, while the parallel component 351 of the counterweight force 305 is absorbed/compensated by the spring 30 the same cannot be said about the transverse component 350. In the depicted design the transverse component 350 is acting on the outer shell 128 of the first segment 12, which could significantly deform the first segment 12.

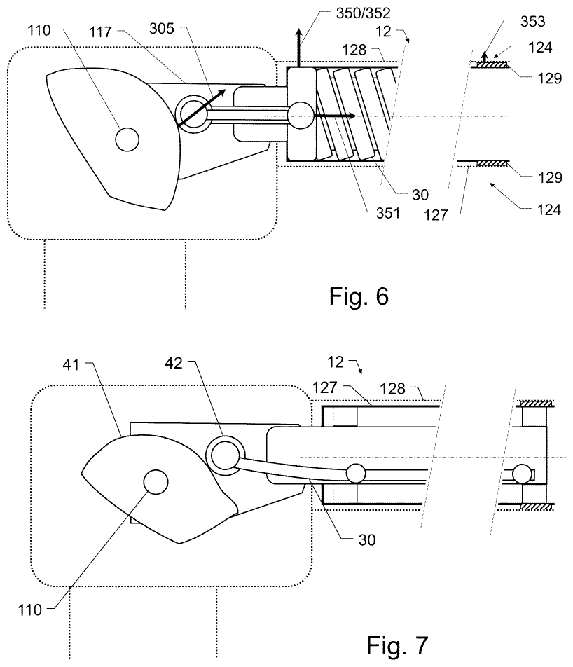

FIG. 6 shows schematically a first embodiment of the inventive counterweight member. The counterweight member is based on analogue concepts and comprises analogue components as the prior art counterweight member shown in FIG. 5. Additional to the first segment shell 128, i.e., the outer wall, the first segment 12 comprises an internal support 127 anchored to the axis 110 of the first hinge, by respective guides 117, such that the internal support can perform a rotation about the axis 110 of the first hinge. The internal support 127 is configured to absorb/compensate the transverse component 350 of the counterweight force 305. The transverse component 350, in the depicted embodiment is essentially the input force 352. The internal support 127 interacts with an interaction area 124 of the first segment 12, in particular the first segment shell 128. The interaction area 124, receiving the output force 353, is located closer to the second hinge than the first hinge, and the internal support 127 have no further points of contact with the first segment shell 128. Due to its own deformation the internal support 127 absorbs/compensates a decisive portion of the transverse component 350 of the counterweight force 305, i.e., the input force 352. The spring 30 similarly absorbs/compensates a decisive portion of the parallel component 351. Due to this construct the output force 353 is of lower magnitude, e.g., negligible, as compared to the input force 352. Thus, the first segment shell 128 is a non-load-bearing component, which is advantageous for the measurement accuracy. In the depicted embodiment interaction sensors 129 are mounted to the interaction areas 124 to provide interaction data between the internal support 127 and the first segment shell 128.

FIG. 7 illustrates a second embodiment of the inventive counterweight member. The force providing element comprises a leaf spring 30 mounted to the internal support 127. The internal support 127 does not exert a considerable force or torque to the first segment shell 128. The leaf spring 30 provides the force directly to a rotary element 42 mounted on the spring 30. The rotary element 42 is in point contact with a static element 41 mounted to the axis 110 of the first hinge. The shape of the static element 41 is configured to set the magnitude of the counterweight torque.

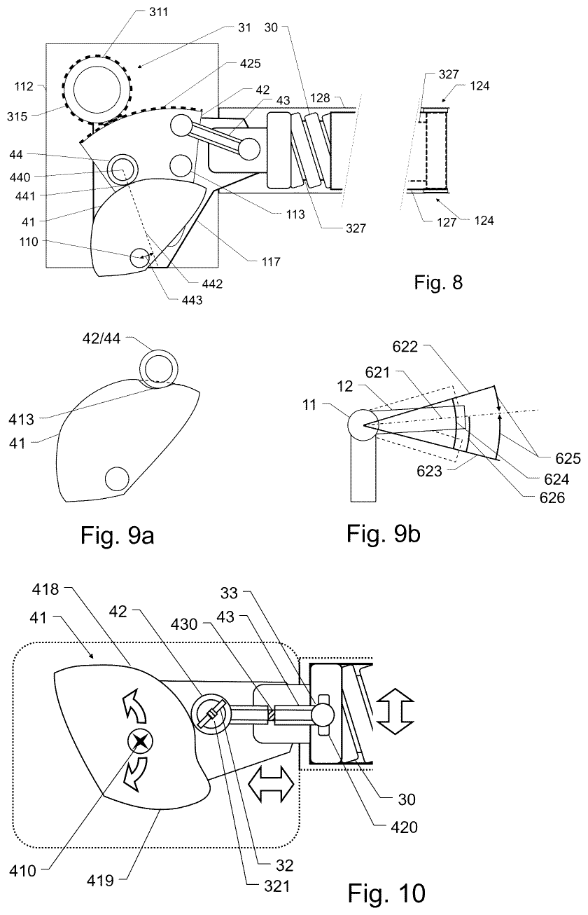

FIG. 8 illustrates a third embodiment of the counterweight member. The depicted force providing element comprises a spring 30 and a motor 31, represented by a gearbox 311. The rotary element 42 is a lever gear configured interact with the gearbox 311 via the respective sets of gears 425,315. The spring 30 is acting on a rotary element 42 via a rod 43. The mechanism comprises a further rotary element 44 mounted to the rotary element 42 and configured to interact with the static element 41. The further rotary element 44 is in point or in line contact with the static element 41. The axis 110 of the first hinge has an offset 443 to a line 442 defined by a contact point 441 between the further rotary element 44 and the static element 41 and the rotation axis 440 of the further rotary element 44. The shape of the static element 41 is configured to define the offset 443 as a function of the rotation state of the first hinge, and with that counterweight torque.

The first segment comprises the rigid first segment shell 128 and the internal support 127. The first segment shell 128 is fixed to the housing 112 of the first hinge, i.e., they rotate together. The interaction of the first segment shell 128 and internal support 127 takes place only in the interaction area 124. A part of the spring 30 and the spring guide 327 is located inside the internal support 127. The spring guide 327 is joined to the internal support 127. Thereby the transverse component of the counterweight force is balanced by a deformation of the spring guide 327 and the internal support 127. The spring guide 327 and the internal support 127 is linked to the housing 112 by respective guides 117. Said guides 117 are also configured to provide a rotation around the axis 110 of the first hinge. The movement of the rotary element 42 is constrained by an interaction respective fixing element 113 and a path provided by the guide 117.

It is clear to the skilled person that the embodiments depicted in FIGS. 6-8 are simplified, schematic illustration. Actual embodiments might comprise further components, e.g. force transfer elements based on levers, wires of gears, friction elements, in particular brakes or locks. The skilled person also understands that the disclosure is not limited to the types of springs depicted, or to embodiments wherein the force providing element comprises a spring.

FIGS. 9a and 9b depict a concave shaped cam as the static element 41. The cam has a neutral point 413 corresponding to a stable position 621 of the first hinge 11 and the first segment 12. A stability range 624 exist around the stable position 621. Within the stability range 624 the net torque 625 acting on the first hinge 11 causes a rotation towards the stable position 621. As depicted in FIG. 9b the stability range 624 can be asymmetric, i.e., the upper limit 622 of the stability range 624 is closer to the stable position 621 than the lower limit 623. It is clear to the skilled person that the neutral point 413 cannot be derived from the shape of the cam 41 alone, but rather a torque balance shall be considered. The torque balance depends on the attitude of the second segment and the further higher order elements as well as the force provided by the force providing element, these input parameters should be considered during the drafting of the design of the cam 41. The concave shape serves illustration purposes only, convex static elements 41 with appropriate change of the slope also provide the described effects.

The static element 41 might comprise a plurality of neutral points 413. The cam 41 might also provide a lift range 626, within the lift range a net torque 625 acting on the first hinge 11 causes an upward rotation of the first hinge 11. In other words, a range between the stable position 621 and the lower limit 623 of the stability range 624 can be understood as a lift range 626.

FIG. 10 depicts some exemplary options to manually adjust the elements of the mechanism or the force providing element. The static element 41 is shown to have a first manual adjustable element 410 to adjust its pose relative to the axis of the first hinge. Such adjustment might be performed to justify the static element 41. Alternatively, the static element 41 might comprise a plurality of surfaces 418,419 and the first manual adjustment element 410 is configured to set one of the plurality of surfaces as active surface. The plurality of surfaces 418,419 are configured to provide different ranges for the magnitude of the counterweight torque, i.e., representing a different operation mode for the CMM. Alternatively or additionally, a plurality of static elements 41 might be mounted on the axis of the first hinge and the first manual adjustable element 410 might set one of the static elements as active static element 41.

Additionally, a slit as second manual adjustment element 420 is shown to adjust a position of a contact 33 between the spring 30 and a rod 43. I.e., the second manual adjustment element 420 indirectly adjusts pose of the rotary element 42 with respect to the spring 30 and/or the static element 41. The depicted rod 43 comprises a grub screw as third manual adjustment element 430. These and similar elements might be utilized to change the length of the spring 30, and the force provided by it. Such elements advantageously allow e.g., a compensation of wear and tear effects arising from the usage of the spring 30. A friction element 32, e.g., a form lock or a centrifugal clutch, is mounted on the rotary element 42 configured to block its rotation. The friction element 32 comprises a user interaction element 321 configured to activate or deactivate the friction element. The type and placement of the friction 32 and user interaction elements 321 is purely illustrative. The disclosure is beneficially combinable with motorized friction elements 32, and/or friction elements 32 arranged on the axis of the first hinge and/or electronic, in particular software-based user interaction elements 321.

The depicted options are non-exclusive, and any similar adjustment element might be used as a standalone element or in combination. Some of the depicted or suitable alternative adjustment options might be performed in a “loaded state”, while other adjustment, in particular a manipulation of the static element 41 or the spring 30 might be preferably performed in a “force-free state”.

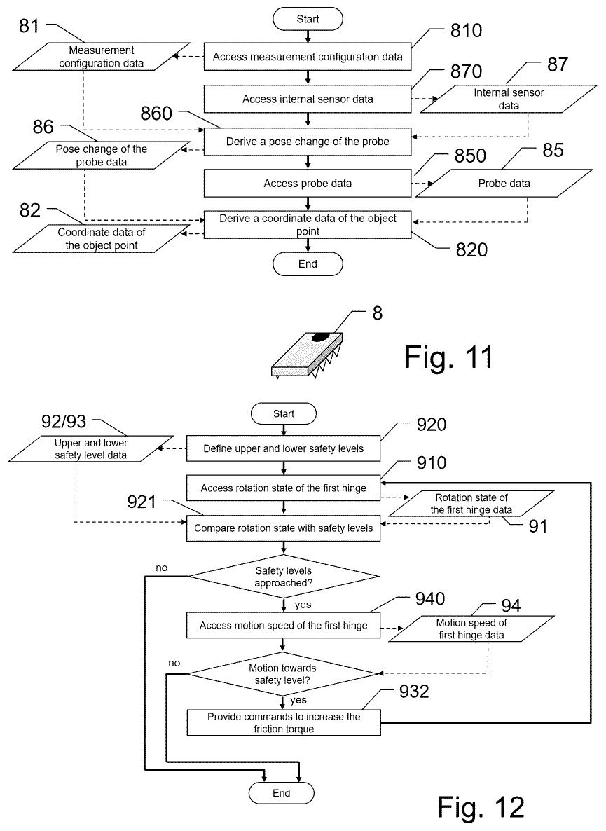

FIG. 11 illustrates a generic method of deriving 820 coordinate data 82 of the object point by a flowchart. Command/flow-lines show as bold and data-lines as dashed arrows. The depicted flowcharts focuses on the essential features of the disclosure and the actual embodiments comprise further, non-depicted elements, in particular command or data elements and/or data transfer lines. Moreover, command or data modules might be depicted in a simplified form due to reasons of clarity and conciseness. The steps of the depicted method might be performed entirely by the control unit 8, depicted as a single microcontroller. The disclosure is not limited to a specific realization of the control unit 8. Alternative embodiments of the control unit 8, e.g., an external computer or a distributed control unit 8, in particular wherein the internal sensors and/or the probe provide pre-processed data, are also applicable.

The control unit 8 accesses 810/870 measurement configuration data 81 representing the geometry, in particular the metrology chain, of the CMM and internal sensor data 87. The internal sensor data 87 is representative of at least a relative motion, preferably a relative pose, provided by the articulated elements. Based on the measurement configuration data 81 and the internal sensor data 87 pose change of the probe 86, preferably data regarding the absolute pose of the probe, is derived 860. The control unit 8 also accesses 850 the probe data 85. The probe data 85 might comprise interaction information between the probe and the object point, or a distance of the two. Based on the pose change of the probe 86 and the probe data 85 coordinate data 82 of the object point is derived 820. There are many variations and alternatives of the here depicted method in the state of the art and the disclosure is not limited to any specific embodiment.

FIG. 12 illustrates an active control of the friction torque based on an upper 92 and lower safety levels 93 and using data regarding the rotation state 91 and a motion 94 of the first hinge. An active control might be foreseen e.g., as part of a crash protection functionality. As a first step the upper 92 and lower safety levels 93 are defined 920. In a next step the rotation state 91 of the first hinge is accessed 910 and compared 921 to the safety levels 92/93. If the rotation state 91 of the first hinge indicates that it is in a danger zone in the proximity of the safety levels 92/93 the motion speed 94 of the first hinge 940 is also accessed. If the first hinge moves towards the relevant safety level 92/93 commands are provided 932 to increase the friction torque until the first hinge comes to a standstill. Many alternatives of the here depicted process exists. E.g., instead of the rotation state and motion speed of the first hinge the parameters of other relevant elements, in particular the probe interface or the second hinge, might be utilized as control parameters. Additionally, commands to reduce the friction torque might also be provided if a motion away from the safety levels 92/93 is detected. Additionally, analogous effects might be reproduced using passive components, in particular springs or eddy-current brakes.

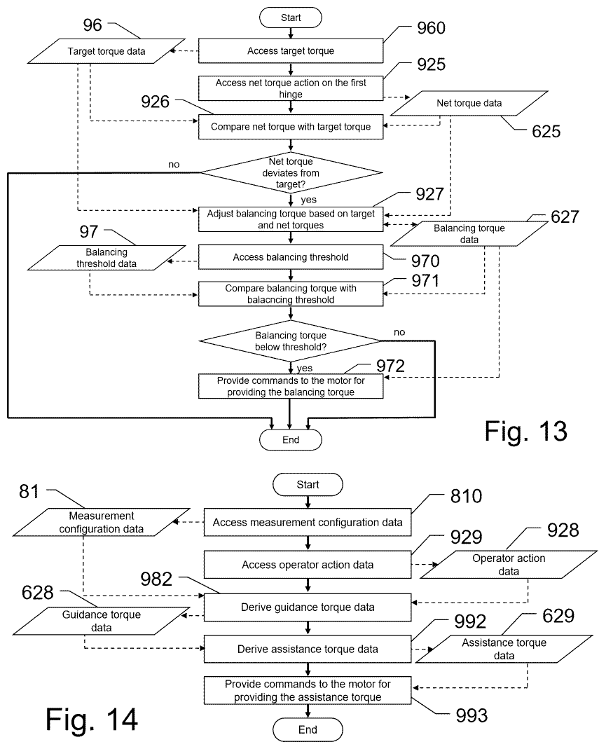

FIG. 13 illustrates an active provision of a balancing torque 627 to set the net torque 625 acting on the first hinge to a target torque value 96, in particular zero. Such active control might be foreseen e.g., as part of a balancing functionality. As a first step the target torque 96 is accessed 960. The target torque 96 might be determined manually or automatically, e.g., based on a measurement task and operator actions or on a perception of the environment. In a next step the net torque 625 acting on the first hinge is accessed 925, e.g., based on sensor data from the first hinge sensor and/or on modeling of the CMM, and compared 926 with the target torque 96. If the net torque 625 deviates from the target torque 96 substantially, the balancing torque 627 is adjusted 927. The adjusted value of the balancing torque 627 is then compared 971 with an accessed 970 balancing threshold 97. If the adjusted balancing torque 627 exceeds the balancing threshold 97 the functionality terminates. Said balancing threshold 97 allows the operator to override the balancing function in a gesture-controlled manner. In other words, firm movements, typically associated with repositioning the probe to a new measurement pose, automatically disable the balancing function. This measure not only provides convenient, intuitive operation, but also protects the motor from overload and reduces the power consumption of the counterweight element. If the balancing torque 627 is below the threshold 97 commands are provided 972 for the motor to provide the balancing torque 627 to the first hinge.

FIG. 14 illustrates an active provision of an assistance torque 629 based on a guidance torque 628 acting on the first hinge due to an operator action relating to a manual guidance of one of the articulated elements by an operator, i.e., holding by hand and moving one of the segments, hinges or the probe interface. The assistance functionality is similar to the balancing functionality of FIG. 13. However, the balancing functionality relates more to a provision a stable pose of the first hinge for improved accuracy and/or ergonomics of usage, whereas the assistance functionality relates more to aiding the movement of the first hinge during certain movements, respectively measurement gestures. In a first step the control unit accesses 810/929 the operator action data 928 and the measurement configuration data 81, in particular regarding the settings of the force providing element, and/or the mechanism, and/or the friction element. Then a guidance torque 628 acting on the first hinge is derived 982 based on the operator action data 928 and the measurement configuration data 81. The assistance torque 629 is derived 992 based on the guidance torque 628. Finally, commands are provided 993 for the motor to provide the assistance torque 629 to the first hinge. Additional or alternative embodiments of the assistance functionality are within the sense of the disclosure. The assistance functionality might comprise advanced features e.g., providing a constant height of the probe interface and/or the second hinge. It is clear to the skilled person that sensible variations of the sequence of the steps illustrated in FIGS. 11-14 are possible within the sense of the disclosure.

Although aspects are illustrated above, partly with reference to some specific embodiments, it must be understood that numerous modifications and combinations of different features of the embodiments can be made. All of these modifications lie within the scope of the appended claims.

1. A coordinate measuring machine comprising a base, a set of articulated elements, a counterweight member, a set of internal sensors, a control unit and a probe, wherein:
the set of articulated elements comprises:
a first segment connected to the base by a first hinge,
a second segment connected to the first segment by a second hinge, and
a probe interface connected to the second segment by a third hinge and
configured to accommodate the probe,
the probe is configured to provide probe data regarding an object point in the environment,
each sensor in the set of internal sensors is associated with at least one of the articulated elements and configured to provide internal sensor data regarding the associated element,
the control unit is configured to derive:
a pose change of the probe based on the internal sensor data, and
coordinate data of the object point based on the internal sensor data and the probe data,
the counterweight member is associated with the first segment and the first hinge and
configured to provide a counterweight torque to the first hinge having an opposite direction to a gravitational torque acting on the first hinge,
wherein the counterweight member comprises a force-providing element and a mechanism, wherein the mechanism comprises:
a rotary element, wherein the force providing element is configured to provide a force to the rotary element,
a static element mounted on an axis of the first hinge and kinematically linked to the rotary element, wherein a shape of the static element is configured to set the counterweight torque as a function of a rotation state of the first hinge, an internal support configured to receive an input force from the rotary element and configured to provide an output force to an interaction area of the first segment, wherein:
the interaction area is located closer to the second hinge than the first hinge, and
the output force has lower magnitude than the input force.

2. The coordinate measuring machine according to claim 1, wherein the first and second segments are elongated and configured to provide a rotation about a rotation axis aligned with the direction of elongation, wherein the first and second segments are substantially cylindrical.

3. The coordinate measuring machine according to claim 1, wherein the force-providing element comprises a spring, wherein the spring:
is a coil spring or a pressure spring, and/or
is located within the first segment and aligned to the rotation axis of the first segment, and/or
is configured to provide a force substantially independent from the rotation state of the first segment.

4. The coordinate measuring machine according to claim 1, wherein the first segment comprises a rigid first segment shell, and the first segment shell interacts with the internal support only through the interaction area, wherein:
an interaction sensor is arranged to the interaction area and configured to provide interaction sensor data regarding the output force.

5. The coordinate measuring machine according to claim 1, wherein the static element is a cam, wherein the mechanism comprises:
a plurality of cams each having different shapes and a selection element configured to set one of the cams to act as the static element, and/or,
a cam comprising a plurality of surfaces and a first manual adjustment element configured to set one of the plurality of surfaces to act as the static element, and/or
a second manual adjustment element configured to adjust the pose of the rotary element, wherein the second manual adjustment element comprises a sliding element, a thread, or a screw; and/or
a third manual adjustment element configured to adjust a magnitude of the force exerted by the force providing element, wherein the third manual adjustment element comprises a sliding element, a thread, an excenter or a screw.

6. The coordinate measuring machine according to claim 1, wherein the shape of the static element is designed:
to provide a stable position and a stability range for the first hinge, wherein within the stability range a net torque, comprising the gravitational and counterweight torques, causes a rotation of the first hinge towards the stable position, and/or
to provide a lift range for the first hinge, wherein within the lift range the net torque causes an upward rotation of the first hinge,
wherein the lift range corresponds to one of:
a vertical position of the probe interface being below a vertical position of the first hinge, and/or
a vertical position of the second hinge being below a vertical position of the first hinge.

7. The coordinate measuring machine according to claim 1, being configured to automatically adjust, based on the pose of the second segment, the force provided by the force providing element, and/or the pose of the rotary element.

8. The coordinate measuring machine according to claim 1, wherein the mechanism comprises a further rotary element kinematically linked to the rotary element, wherein:
a rotation of the rotary element causes a position change of a rotation axis of the further rotary element along a constrained path,
the further rotary element is in point or line contact with the static element, the axis of the first hinge has an offset to a line defined by a contact point between the further rotary element and the static element and the rotation axis of the further rotary element, and
the shape of the static element is configured to define the offset as a function of the rotation state of the first hinge,
wherein the rotary element is a lever gear and the further rotary element is a roller mounted on the lever gear in a position offset to a rotation axis of the level gear.

9. The coordinate measuring machine according to claim 1, wherein the counterweight member comprises a friction element configured to provide a friction torque for the first hinge, wherein the friction element:
is comprised by the mechanism, arranged to the axis of the first hinge, and
causes a motionless parking state of the first hinge, by blocking the rotation of the rotary element, in an absence of forces exerted by the operator on one of the articulated elements and/or as a result of a parking command provided by the operator.

10. The coordinate measuring machine according to claim 9, wherein the friction element is configured to provide a non-linear change of the friction torque dependent on:
the rotation state and/or a motion speed of the first hinge, and/or
the rotation state and/or a motion speed of the probe interface
wherein the friction element comprises:
a flex rachet handle configured to block a downward a movement of the first hinge in an engaged state, and
a user interaction element arranged to the proximity of the flex rachet handle and configured to activate and deactivate the engaged state.

11. The coordinate measuring machine according to claim 9, wherein:
an upper and/or a lower safety level is defined regarding the rotation state of the first hinge, and
the friction element is configured to provide an increment of the friction torque when the rotation state of the first hinge approaches one of the safety levels.

12. The coordinate measuring machine according to claim 11, wherein:
the set of internal sensors provides crash protection data based on the rotation state of the first hinge, and
the control unit is configured to provide commands for the increment of the friction torque based on the crash protection data.

13. The coordinate measuring machine according to claim 1, wherein
the rotary element is a geared wheel, geared belt or geared lever,
the force providing element comprises a motor, and
the control unit is configured to provide control commands to the motor,
in particular wherein
the friction element comprises the motor, and/or
the motor comprises a gearbox, and the rotary element is in contact with the gearbox.

14. The coordinate measuring machine according to claim 3, wherein:
a first hinge sensor is configured to provide net torque data regarding the net torque acting on the first hinge, and
the control unit is configured to provide a balancing functionality comprising:
accessing and processing the net torque data,
providing commands to the motor to provide a balancing torque such that the net torque acting on the first hinge approaches a target torque, in particular zero,
wherein the balancing torque is limited:
to a magnitude of ±30%, more particularly ±20%, of the counterweight torque, and/or by a balancing threshold such that the balancing functionality is deactivated if the balancing torque exceeds the balancing threshold, in response to an operator action.

15. The coordinate measuring machine according to claim 13, wherein coordinate measuring machine:
comprises an operator action sensor configured to provide operator action data regarding an operator guidance of one of the articulated elements,
is configured to access measurement configuration data regarding settings of the force providing element, and/or the mechanism, and/or the friction element,
is configured to provide an assistance functionality comprising:
receiving and processing the operator action data,
deriving a guidance torque acting on the first hinge based on the operator action data and the measurement configuration data, and
providing commands to the motor to provide an assistance torque acting on the first hinge, wherein the assistance torque has the same direction and at least the same magnitude as the guidance torque.

16. The coordinate measuring machine according to claim 1, wherein:
the counterweight member is a first counterweight member, and
the coordinate measuring machine comprises a second counterweight member associated with the second hinge,
wherein the second counterweight member configured to provide a second counterweight torque to the second hinge having an opposite direction to a second gravitational torque acting on the second hinge.

17. The coordinate measuring machine according to claim 16, wherein the second counterweight member comprises:
a second force-providing element, and
a second mechanism comprising a second static element mounted on an axis of the second hinge and wherein a shape of the second static element is configured to set the second counterweight torque.
